(19) United States
(12) Patent Application Publication
(10) Pub. No.: US 2018/0094723 A1
(43) Pub. Date: Apr. 5, 2018

(54) SYSTEM FOR RATIONALIZING MEASURED GEAR RATIO VALUES IN A VEHICLE PROPULSION CONTROL SYSTEM

(71) Applicant: GM GLOBAL TECHNOLOGY OPERATIONS LLC, Detroit, MI (US)

(72) Inventors: Ronald F. Lochocki, JR., Ypsilanti, MI (US); Moussa Ndiaye, Canton, MI (US); Bret Olson, White Lake, MI (US); Paul G. Otanez, Franklin, MI (US); Mark S. Reinhart, Oak Park, MI (US); Jeryl McIver, Inkster, MI (US)

(21) Appl. No.: 15/286,080

(22) Filed: Oct. 5, 2016

(51) Int. Cl. F16H 61/688; F16H 61/66

(52) U.S. Cl. CPC F16H 61/688; F16H 61/66

(57) ABSTRACT

A controller for a vehicle propulsion system that includes a prime mover, a transmission connected to the prime mover to receive input torque on an input shaft and to convert the input torque to an output torque on an output shaft, a transmission input shaft speed sensor, and a transmission output shaft speed sensor. The controller provides a gear ratio value that is based upon a signal indicating an operating condition of the transmission other than a signal from the transmission input shaft speed sensor and the transmission output shaft sensor.

### FIELD

The present disclosure relates to a system that rationalizes measured gear ratio values in a vehicle propulsion control system.

### INTRODUCTION

This introduction generally presents the context of the disclosure. Work of the presently named inventors, to the extent it is described in this introduction, as well as aspects of the description that may not otherwise qualify as prior art at the time of filing, are neither expressly nor impliedly admitted as prior art against this disclosure.

Motorized vehicles include a prime mover that generates input torque. The received input torque is transmitted across an input shaft to a transmission. The transmission receives the input torque and converts it to an output torque on an output shaft. The output torque is a multiple of the input torque and a gear ratio of the transmission.

Typically, the prime mover is controlled such that it provides a desired or commanded amount of input torque. A controller generally determines the desired amount of input torque to request or command from the prime mover by determining a desired amount of axle torque or other output torque and dividing that desired amount of axle torque by the gear ratio of the transmission. The gear ratio is typically calculated in a processor in a controller based upon signals from a transmission input shaft speed sensor and a transmission output shaft speed sensor. However, these sensors, signals and the resultant values used by the processor may be susceptible to fault, error and/or corruption. Computers are susceptible to corruption due to ultraviolet light, electromagnetic pulse, temperature variations and many other factors which are too numerous to list. In the instance that a fault or other error causes an inaccurate or corrupted gear ratio value, the command, control, and/or request sent to an engine control may be inaccurate. In instances where the system is able to identify and detect these faults, drastic measures may be taken such as, for example, to immediately enter into a safe mode which may significantly reduce power from the prime mover and/or entry into a transmission mode which protects the vehicle.

### SUMMARY

In an exemplary aspect, a vehicle includes a prime mover for generating an input torque on an input shaft, a transmission connected to the prime mover that is configured to receive the input torque from the input shaft and produce an output torque on an output shaft, a transmission input shaft speed sensor, a transmission output shaft speed sensor, and a controller in communication with the transmission. The controller is programmed to provide a gear ratio value that is based upon a signal indicating an operating condition of the transmission other than a signal from the transmission input shaft speed sensor and the transmission output shaft sensor.

In another exemplary aspect, the controller is further programmed to determine the type of transmission, to identify an enumerated gear and to rationalize the identified enumerated gear based upon the provided gear ratio.

In another exemplary aspect, the controller provides a gear ratio value that is based upon a current operating condition of the transmission.

In another exemplary aspect, the transmission includes a clutch to clutch transmission and the gear ratio is based upon a current operating condition of a clutch in the clutch to clutch transmission.

In another exemplary aspect, the transmission includes a dual clutch transmission and the gear ratio is based upon the current operating condition of a fork and a clutch in the dual clutch transmission.

In another exemplary aspect, the transmission includes a continuously variable transmission and the gear ratio is based upon a current operating condition of the continuously variable transmission.

In another exemplary aspect, the controller provides a gear ratio value that is based upon a previously commanded operating condition of the transmission.

In another exemplary aspect, the transmission includes a clutch to clutch transmission and the gear ratio is based upon the previously commanded operating condition of the clutches in the clutch to clutch transmission.

In another exemplary aspect, the transmission includes a dual clutch transmission and the gear ratio is based upon the previously commanded operating condition of a fork and a clutch in the dual clutch transmission.

In another exemplary aspect, the transmission includes a continuously variable transmission and the gear ratio is based upon the previously commanded operating condition of the continuously variable transmission.

In this manner, an exemplary embodiment of the present invention provides an alternative transmission gear ratio that may be compared to and/or substituted for a conventionally derived transmission gear ratio based upon the quality and/or reliability of the signals. In this manner, a corrupted signal and/or faulty sensor does not necessarily result in a complete shutdown and/or immediate entry into a safe mode. The engine may be kept running and is not immediately turned off. Further, in this manner, unintended accelerations may be avoided.

Further areas of applicability of the present disclosure will become apparent from the detailed description provided below. It should be understood that the detailed description and specific examples are intended for purposes of illustration only and are not intended to limit the scope of the disclosure.

The above features and advantages, and other features and advantages, of the present invention are readily apparent from the detailed description, including the claims, and exemplary embodiments when taken in connection with the accompanying drawings.

### BRIEF DESCRIPTION OF THE DRAWINGS

The present disclosure will become more fully understood from the detailed description and the accompanying drawings, wherein:

FIG. 1 is a schematic illustration of an exemplary vehicle having a transmission and controller programmed to execute a gear ratio rationalization method;

FIG. 2 is a schematic illustration of an exemplary command structure for a gear ratio rationalization system;

FIG. 3 is an exemplary clutch sequencing table.

### DETAILED DESCRIPTION

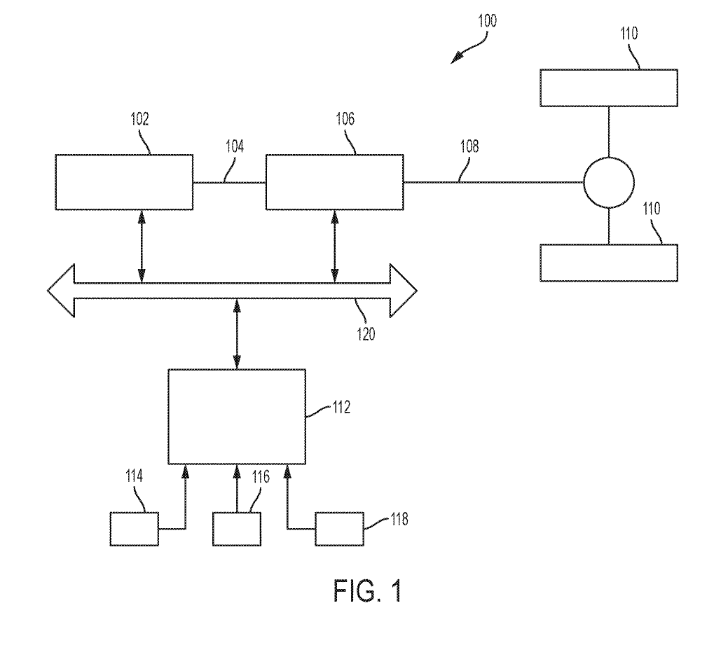

Referring to FIG. 1, an exemplary vehicle 100 is schematically depicted with a prime mover 102, e.g., an engine, an electric motor, and/or the like. The prime mover 102 provides torque to an input shaft 104 which is connected to a transmission 106. The transmission converts the input torque from the input shaft 104 to an output torque on an output shaft 108 based upon a gear ratio of the transmission 106. The output shaft 108 may form a portion of or connect to a drive axle that powers drive wheels 110 which propel the vehicle 100. The desired input torque from the prime mover on the input shaft 104 is governed according to the following equation:

Tₑ=Tₐₓₗ/Ratio (1)

Where: Tₑ is the desired input torque on the input shaft (also known as engine torque), Tₐₓₗ is the desired output torque on the output shaft (also may be known as the axle torque), and ratio represents all of the gear ratios between the engine 102 and the drive wheels 110. That ratio may include multiple components depending upon the specific powertrain configuration. For example, the ratio for a powertrain may include ratio components for each of a torque converter, a transfer case, a final drive, a chain drive, and/or the like. In general, the portion of the Ratio corresponding to any one or all of these components do not vary or vary very little. By contrast, the largest variance that effects the value of that ratio is the transmission gear ratio (TGR). The transmission 106 may be of any type, for example, a clutch to clutch, a dual clutch, a constantly variable transmission or the like without limitation. The transmission 106 serves to convert the speed and torque received from the input shaft 104 to a different speed and torque provided to the output shaft 108.

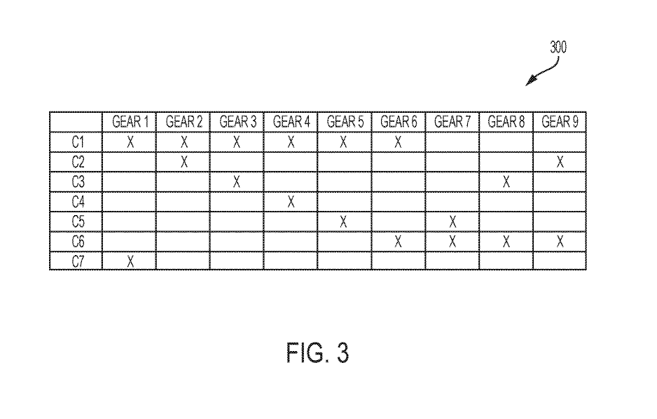

The vehicle 100 further includes a controller 112 that is programmed to execute a method 300 for rationalizing gear ratio as is explained in more detail below and in reference to FIGS. 3A-3D. The controller 112 is in communication with a user interface such as, for example, a pedal position sensor 114, and also communicates with a transmission input speed sensor 116 and a transmission output speed sensor 118. Although FIG. 1 shows controller 112 as a single component, the controller 112 may include any number of separate modules and/or components, such as an engine control module and/or a transmission control module, which are located together or distributed across a local network and which may communicate with each other using a controller area network bus (which may also be known as a CAN bus) 120, without limitation.

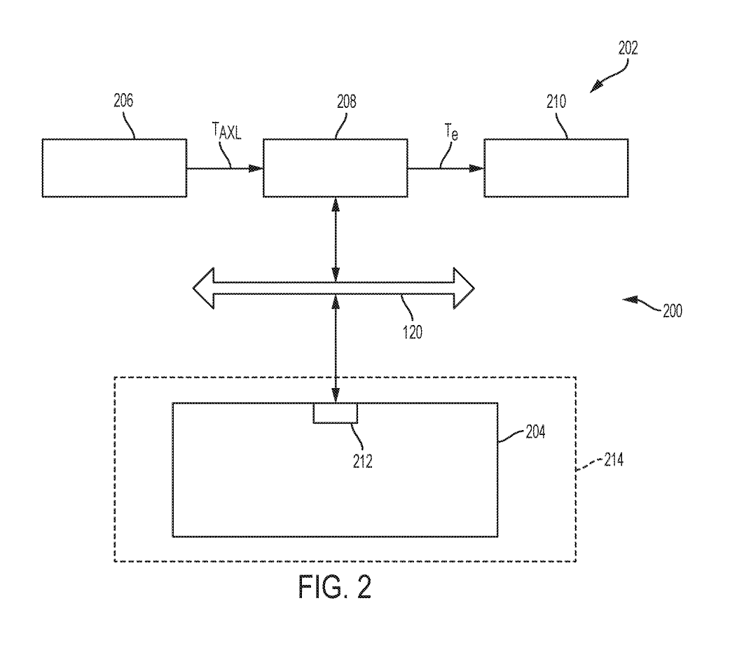

Referring now to FIG. 2, a schematic of an exemplary gear ratio rationalization system 200 is illustrated. The components in the system 200 correspond to modules or subroutines programmed into the controller 112 to execute a gear ratio rationalization method. The gear rationalization system 200 includes an engine torque backbone 202 and a transmission power transfer backbone 204 that communicate with each other via the controller area network bus 120. The engine torque backbone 202 provides a command structure for the engine control system. The engine torque backbone 202 includes a torque request module 206, an axle torque arbitration module 208, and a prime mover torque controller 210. The torque request module 206 may communicate with the user interface 114, such as a pedal position sensor, the transmission output shaft sensor 118, and the like without limitation. The torque request module 206 generates an axle torque request based upon a request for axle torque from a user interface, such as the pedal position sensor, and the like. The axle torque arbitration module 208 receives the axle torque request from the torque request module 206 and generates an arbitrated prime mover torque request. The axle torque arbitration module 208 may determine the arbitrated prime mover torque request based upon the axle torque request received from the torque request module 206 and torque requests received from other components and/or modules, such as, for example, a traction control module which may request a modification of the torque based upon measured slip of the drive wheels 110, a transmission control module which may request a modification of the torque based upon the torque capacity of the transmission 106, or the like without limitation.

Further, the axle torque arbitration module 208 may receive a secure torque gear ratio, sTGR 212, from the transmission power transfer backbone 204 via the controller area network 120 and may output an arbitrated prime mover torque request that is calculated based upon equation (1) provided above. In other words, the arbitrated prime mover torque request may be calculated by dividing an output torque with a transmission gear ratio. To avoid unintended errors or consequences, the transmission gear ratio that is used by the axle torque arbitration module 208 is a secure transmission gear ratio (sTGR) 212 that is received from the transmission power transmission backbone 204 via the controller area network 120. The secure transmission gear ratio sTGR 212 has been rationalized by the transmission power transfer backbone 204 to minimize and/or reduce the risk of faults, errors, or corruption of the value for the transmission gear ratio.

The axle torque arbitration module 208 provides the arbitrated prime mover torque request to the prime mover torque control 210. The prime mover torque control 210 operates to control the prime mover 102 in a manner which will result in the prime mover providing an input torque on the input shaft 104 which corresponds to the arbitrated prime mover torque request received from the axle torque arbitration module 208. For example, the prime mover torque control 210 for an internal combustion engine may include an engine control module that converts the torque request into commands to the engine that control spark, fuel, variable valve timing, electronic throttle control and the like without limitation to cause the engine to output the requested torque.

As explained above, the transmission power transfer backbone 204 provides a secure transmission gear ratio 212 (sTGR) to the engine torque backbone 202. The secure transmission gear ratio is stored in a lockable protected memory as is described in detail below.

In an exemplary embodiment of the present invention, the transmission power transfer backbone 204 may determine a transmission gear ratio several different ways and based upon a perceived quality of each potential value or based upon faults being detector or not may rank them and compare them to each other to rationalize the value which is then selected and stored as the secure transmission gear ratio sTGR 212. For example, in an instance where a fault is detected in a signal which may be used to generate a candidate transmission gear ratio the transmission power transfer backbone 204 may select a different method for calculating a transmission gear ratio and store that different value as the secure transmission gear ratio sTGR 212 because it may be more reliable and of higher quality.

Additionally, even in the absence of any fault, detected or otherwise, the inventive system of providing a transmission gear ratio value which is not based upon a transmission input shaft speed sensor and a transmission output shaft speed sensor (i.e. TIS/TOS), provides another candidate value against which the TIS, TOS derived transmission gear ratio value may be rationalized. If the value for the transmission gear ratio that is generated using TIS and TOS signals exceeds the range of values or boundaries which are derived from other known characteristics, kinematic signal value, configuration commands sent to the transmission, then a decision may be made to substitute another value for the TIS/TOS or other value for the secure transmission gear ratio sTGR 212. Further, this condition provides the opportunity to take other potentially remedial methods, such as placing the prime mover and/or transmission into a safe mode.

Different types of transmissions may require different types of methods to rationalize the gear ratio. While the exemplary embodiments described herein may illustrate methods associated with a clutch to clutch type transmission, a dual clutch transmission, and a continuously variable transmission, the method and system of the present invention is applicable to any type of transmission without limitation. Those of ordinary skill in the art understand that each type of transmission may provide the ability to estimate or rationalize a transmission gear ratio without direct reliance upon a transmission input shaft speed sensor and/or a transmission output shaft speed sensor, or the like.

A clutch to clutch type transmission may be, for example, an automatic transmission with a system of planetary gear sets with having components that are selectively locked and unlocked using friction clutches. In this exemplary embodiment the present invention has the opportunity to determine a gear box ratio based upon the commanded or known clutch configuration. The system controlling the gearbox, e.g., a transmission control module 214 which may include the transmission power transfer backbone 204, monitors and commands clutch and fill pressure controls. The transmission control module 214 knows the current commanded clutch configuration and the clutch configuration which has been commanded previously. Using the clutch configuration, the system may infer a gear ratio using, for example, a clutch sequencing chart which is well understood. An exemplary clutch sequencing table 300 is illustrated in FIG. 3. The clutch sequencing table 300 enables determination of a gear ratio based upon which clutches (C1, C2, C3, etc.) are engaged. For example, if the transmission control module has previously commanded clutches C1 and C7 to engage, then we know that the gear ratio corresponding to “gear 1” is correct. Thus, even in an instance where transmission sensors may have been lost, the transmission control module 214 may know the clutch configuration that was commanded during the previous three controller loops and the system may then infer that the transmission continues to be in the gear ratio corresponding to that clutch configuration. In other words, the system relies upon knowledge of the kinematics of the transmission system and the history of the commanded or controlled configuration for that transmission system to determine a gear ratio without necessarily relying upon a transmission input speed sensor and/or transmission output speed sensor.

In an exemplary embodiment of the invention, the transmission gear ratio derived from the TIS and TOS signals may be compared to the candidate transmission gear ratio that is calculated with reference to the clutch sequencing table 300. If the TIS and TOS derived transmission gear ratio differs from the candidate transmission gear ratio than a decision may be made to replace that the TIS and TOS derived value with the candidate transmission gear ratio to be stored in the lockable, protected memory 212 as the secure transmission gear ratio sTGR.

Similarly, if the transmission 106 is a dual clutch type transmission, another exemplary embodiment may determine a gear box ratio based upon the commanded or known fork and clutch configuration. The system controlling the gearbox, e.g., a transmission control module 214 which may include the transmission power transfer backbone 204, monitors and commands clutch and fork controls. The transmission control module 214 knows the current commanded clutch and fork configuration and the clutch and fork configuration which has been commanded previously. For example, even in an instance where transmission sensors may have been lost, the transmission control module 214 may know the clutch and fork configuration that was commanded during the previous three controller loops and the system may then infer that the transmission continues to be in the gear ratio corresponding to that clutch and fork configuration. In other words, the system relies upon knowledge of the kinematics of the transmission system to determine a gear ratio without relying upon a transmission input speed sensor and/or transmission output speed sensor.

Alternatively, if the transmission 106 is a continuously variable transmission, the exemplary embodiment may substitute a value from another speed sensor (which may be referred to as TNSR) on the CVT upstream of the primary variator pulley for TIS. Or, if the exemplary embodiment determines that the TOS is fault pending or fault active, then the system may substitute a secure vehicle speed signal for the TOS signal value. A secure vehicle speed is well known and understood by those of ordinary skill in the art to be equivalent to wheel speed multiplied by a final drive gear ratio (a gear ratio between the transmission output shaft and the wheels).

Alternatively, an exemplary embodiment may estimate a transmission gear ratio that may be a function of multiple different well known and understood factors and characteristics which may be known and relevant to the operation of the CVT such as, for example, engine torque (Te), variator torque (Tvar), safety factor (TCR), measured primary pulley pressure (Pp), measured secondary pulley pressure (Ps), primary pulley speed (Wp), secondary pulley speed (Ws), wheel speed, a speed sensor upstream of the primary variator pulley (TNSR), temperature, a ratio of primary to secondary pulley force to hold a ratio (KpKs), speed ratio (which is TOS/TIS, the inverse of the transmission gear ratio) and the like without limitation. When controlling a CVT, commanded pulley pressures Pp and Ps may be commanded according to a function of speed ratio, safety factor, variator torque, primary pulley speed, temperature, secondary pulley speed, and the like either through the use of equations or a look-up table. Using these commanded pressures, we can calculate a force for each respective pulley by multiplying the respective pressure by the area of the pulley apply piston. The ratio of primary to secondary pulley force to hold ratio, KpKs, may then be determined being equal to the ratio of the primary pulley force over the secondary pulley force.

A speed ratio (SR) may then be approximated within a range, typically with a look-up table using one or more of these values such as, for example, KpKs, Tvar, TCR, temperature, Wp and Ws, and the like without limitation. Since the speed ratio may only be determined within a range, we may only be able to provide a boundary for the inverse of the speed ratio (i.e. the transmission gear ratio). It is these boundaries of this range that may determine whether the transmission gear ratio determined above is reliable. If the exemplary embodiment determines that the transmission gear ratio is not reliable (i.e. outside the boundaries), then the method may store a different gear ratio (a conservative gear ratio such as a predetermined ratio that represents a potentially worst case scenario that would provide the greatest torque multiplication, i.e. the first gear ratio) in the lockable protected memory as the secure transmission gear ratio 212.

Alternatively, if the method determines that the transmission gear ratio reliable (i.e. within the boundaries), then the method may store that transmission gear ratio in the lockable protected memory as the secure transmission gear ratio 212.

Optionally, and preferably, when a fault is pending, or active, and when a gear ratio is being determined using any method other than dividing the transmission input shaft speed by the transmission output shaft speed, additional warning signals and/or measures may be taken. For example, a secure vehicle speed signal may be of a lower resolution and of lower quality than the transmission output shaft sensor signal that it may be replacing. In that instance, the signal is understood to be somewhat degraded and additional measures may be taken in recognition of this degradation.

The value stored as the secure transmission gear ratio 212 may also be protected by other overlapping and cooperative technologies which provide a secure computing environment. A secure computing environment may rely upon parallel processors, error correcting code that policies random bit flips, stack overflow protection, a program sequence watch, and the like. A program sequence watch requires that designated process are called during every loop that the process is scheduled to be called. There is a list in the program sequence watch in each of the multiple controllers where key subroutine calls are required to be called every loop. Parallel processing requires two separate and independent processes which run in parallel and which constantly compare outputs with each other. Any divergence in outputs is a violation. Violations of any one of these protections may result in a processor shutdown.

As referenced above, the secure transmission gear ratio 212 is stored in lockable protected memory. There may be two copies of the secure transmission gear ratio 212 on two different controllers in the transmission power transfer backbone 204. If something tries to access one of the copies without the use of a proper call, a processor shutdown is invoked and the powertrain may enter into a safe state. Only special calls to the secure transmission gear ratio 212 may be permitted access to the lockable protected memory of the secure transmission gear ratio 212.

Another level of protection may be provided by network protocols operating on the controller area network 120. The engine torque backbone 202 may receive the secure transmission gear ratio 212 from the transmission power transfer backbone 204 via the controller area network 120. Therefore, the engine control module (not shown) may not be receiving carefully timed signals from either the transmission input speed sensor or transmission output speed sensor does not independently calculate any transmission gear ratio. Rather, the engine torque backbone 202 only has access to a transmission gear ratio value that is provided via the controller area network 120. The controller area network 120 operates using secure network transmission protocols which are well known in the art to ensure that the data provided by the controller area network, including the secure transmission gear ratio 212 is protected.

Further, an exemplary embodiment of the present invention may identify an enumerated gear and to rationalize the identified enumerated gear based upon the gear ratio that is based upon an operating condition of the transmission other than a signal from the transmission input shaft sensor and the transmission output shaft sensor.

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A vehicle comprising:
a prime mover operable for generating an input torque on an input shaft;
a transmission connected to the prime mover that is configured to receive the input torque from the input shaft and produce an output torque on an output shaft;
a transmission input shaft speed sensor;
a transmission output shaft speed sensor; and
a controller in communication with the transmission, wherein the controller is programmed to provide a gear ratio value that is based upon an operating condition of the transmission other than a signal from the transmission input shaft speed sensor and the transmission output shaft sensor.

2. The vehicle of claim 1, wherein the controller is further programmed to determine the type of transmission, to identify an enumerated gear and to rationalize the identified enumerated gear based upon the provided gear ratio.

3. The vehicle of claim 1, wherein the controller provides a gear ratio value that is based upon a current operating condition of the transmission.

4. The vehicle of claim 3, wherein the transmission comprises a clutch to clutch transmission and wherein the gear ratio is based upon a current operating condition of a clutch in the clutch to clutch transmission.

5. The vehicle of claim 3, wherein the transmission comprises a dual clutch transmission and wherein the gear ratio is based upon the current operating condition of a fork and a clutch in the dual clutch transmission.

6. The vehicle of claim 3, wherein the transmission comprises a continuously variable transmission and wherein the gear ratio is based upon a current operating condition of the continuously variable transmission.

7. The vehicle of claim 1, wherein the controller provides a gear ratio value that is based upon a previously commanded operating condition of the transmission.

8. The vehicle of claim 7, wherein the transmission comprises a clutch to clutch transmission and wherein the gear ratio is based upon the previously commanded operating condition of the clutches in the clutch to clutch transmission.

9. The vehicle of claim 7, wherein the transmission comprises a dual clutch transmission and wherein the gear ratio is based upon the previously commanded operating condition of a fork and a clutch in the dual clutch transmission.

10. The vehicle of claim 7, wherein the transmission comprises a continuously variable transmission and wherein the gear ratio is based upon the previously commanded operating condition of the continuously variable transmission.

11. A controller for rationalizing a gear ratio for a vehicle propulsion system, the vehicle propulsion system including a prime mover, a transmission connected to the prime mover to receive input torque on an input shaft and to convert the input torque to an output torque on an output shaft, a transmission input shaft speed sensor, and a transmission output shaft speed sensor, the controller is programmed to provide a gear ratio value that is based upon a signal indicating an operating condition of the transmission other than a signal from the transmission input shaft speed sensor and the transmission output shaft sensor.

12. The controller of claim 11, wherein the controller is programmed to determine the type of transmission.

13. The controller of claim 11, wherein the controller provides a gear ratio value that is based upon a current operating condition of the transmission.

14. The controller of claim 13, wherein the transmission comprises a clutch to clutch transmission and wherein the gear ratio is based upon a current operating condition of a clutch in the clutch to clutch transmission.

15. The controller of claim 13, wherein the transmission comprises a dual clutch transmission and wherein the controller provides a gear ratio value that is based upon the current operating condition of a fork and a clutch in the dual clutch transmission.

16. The controller of claim 13, wherein the transmission comprises a continuously variable transmission and wherein the controller provides a gear ratio value that is based upon a current operating condition of the continuously variable transmission.

17. The controller of claim 11, wherein the controller provides a gear ratio value that is based upon a previously commanded operating condition of the transmission.

18. The controller of claim 17, wherein the transmission comprises a clutch to clutch transmission and wherein the controller provides a gear ratio value that is based upon the previously commanded operating condition of the clutches in the clutch to clutch transmission.

19. The controller of claim 17, wherein the transmission comprises a dual clutch transmission and wherein the controller provides a gear ratio value that is based upon the previously commanded operating condition of a fork and a clutch in the dual clutch transmission.

20. The controller of claim 17, wherein the transmission comprises a continuously variable transmission and wherein the controller provides a gear ratio value that is based upon the previously commanded operating condition of the continuously variable transmission.
